(19) United States
(12) Patent Application Publication
(10) Pub. No.: US 2004/0199910 A1
(43) Pub. Date: Oct. 7, 2004

(54) Automated change back off process for restoring the root disk

(76) Inventor: James E. Baack, Aubrey, TX (US)

Correspondence Address: THE LAW OFFICE OF STEPHEN R. LOE, P.O. Box 649, Frisco, TX, 75034, US

(21) Appl. No.: 10/674,219

(22) Filed: Sep. 29, 2003

Related U.S. Application Data
(60) Provisional application No. 60/460,669, filed on Apr. 5, 2003.

(51) Int. Cl. G06F 9/44

(52) U.S. Cl. 717/171

(57) ABSTRACT

A method, system, and computer program product for updating software on a data processing system, such as a server, having a root partition and a mirrored partition is provided. In one embodiment, a preparation function is executed on the data processing system. Responsive to a determination that the preparation function completed successfully, the root mirroring function of the data processing system is broken such that changes to the root partition do not affect the mirrored partition. Next, the root partition of the data processing system is upgraded using, for example, a software patch. Responsive to a determination that the upgrade to the root partition of the data processing system was unsuccessful, recovering the original state of the root partitions using the mirrored partition which still contains the original state of the root partition.

### PRIORITY

This application claims the benefit of the filing date of corresponding U.S. Provisional Patent Application Serial No. 60/460,669, entitled “A Scripted Automated Change Back Off Process for Restoring the Root Disk”, filed Apr. 5, 2003, the contents of which are hereby incorporated herein for all purposes.

### BACKGROUND OF THE INVENTION

1. Technical Field

The present invention relates generally to computer software and, more particularly, to method for restoring the root disk of a server in a network environment.

2. Description of Related Art

The use of computers at all levels of society has increased dramatically since the early 1980's. Initially, the surge in computer growth in the early 1980's was largely due to the personal computer. Although this growth in personal computing still continues, the advent of the “Internet” and other distributed computing environments in which content and/or functionality resided at a remote “server” data processing system has propelled growth in servers.

To emphasize this shift in direction, consider the following. The “Internet” is a worldwide network of computers. Today, the Internet is made up of more than 65 million computers in more than 100 countries covering commercial, academic and government endeavors. Originally developed for the U.S. military, the Internet became widely used for academic and commercial research. Users had access to unpublished data and journals on a huge variety of subjects. Today, the Internet has become commercialized into a worldwide information highway, providing information on every subject known to humankind.

The Internet's surge in growth in the latter half of the 1990s was twofold. As the major online services (AOL, CompuServe, etc.) connected to the Internet for e-mail exchange, the Internet began to function as a central gateway. A member of one service could finally send mail to a member of another. The Internet glued the world together for electronic mail, and today, the Internet mail protocol is the world standard.

Secondly, with the advent of graphics-based Web browsers such as Mosaic and Netscape Navigator, and soon after, Microsoft's Internet Explorer, the World Wide Web took off. The Web became easily available to users with PCs and Macs rather than only scientists and hackers at UNIX workstations. Delphi was the first proprietary online service to offer Web access, and all the rest followed. At the same time, new Internet service providers rose out of the woodwork to offer access to individuals and companies. As a result, the Web has grown exponentially providing an information exchange of unprecedented proportion. The Web has also become “the” storehouse for drivers, updates and demos that are downloaded via the browser. All of these things are supplied by Web servers. Thus, it is clear that the need for servers has increased dramatically during the last few decades.

However, Web based applications are not the only areas spurring the need for servers. Corporations and other Enterprises increasingly rely on distributed based computing environments to carry out many business and other functions, thus utilizing servers.

Because technology changes rapidly, the software for the servers need to be upgraded from time to time. However, the complexity of preparing a server for upgrades or patches can be immense as compared to a personal computer due to a number of reasons, such as, for example, the fact that numerous users, rather than a single user, rely on the server.

Due to the complexity in upgrading servers, extra time is required to ensure the series of manual steps is followed correctly, which includes the proper commands and syntax. If the upgrades or patches are not successful, there is more complexity and time involved with restoring the server back to the state it was in before the upgrades or patches were applied. If the upgrades or patches are successful, there is some complexity and time involved with retaining them and also re-establishing the mirror of the disk. Because of this complexity and because of the significant involvement of a person such as a system administrator, there is significant potential for error. Therefore, it would be desirable to have a method, system, and product that provides a simpler and surer method of updating a server that reduces the amount of involvement needed by a human administrator.

### SUMMARY OF THE INVENTION

The present invention provides a method, system, and computer program product for updating software on a data processing system, such as a server, having a root partition and a mirrored partition. In one embodiment, a preparation function is executed on the data processing system. Responsive to a determination that the preparation function completed successfully, the root mirroring function of the data processing system is broken such that changes to the root partition do not affect the mirrored partition. Next, the root partition of the data processing system is upgraded using, for example, a software patch. Responsive to a determination that the upgrade to the root partition of the data processing system was unsuccessful, recovering the original state of the root partitions using the mirrored partition which still contains the original state of the root partition.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented; and

FIG. 4 depicts a diagram illustrating program function and process flow for upgrading a server and for restoring a root disk for the server if the upgrade fails in accordance with one embodiment of the present invention.

### DETAILED DESCRIPTION OF THE PREFERRED EMBODIMENT

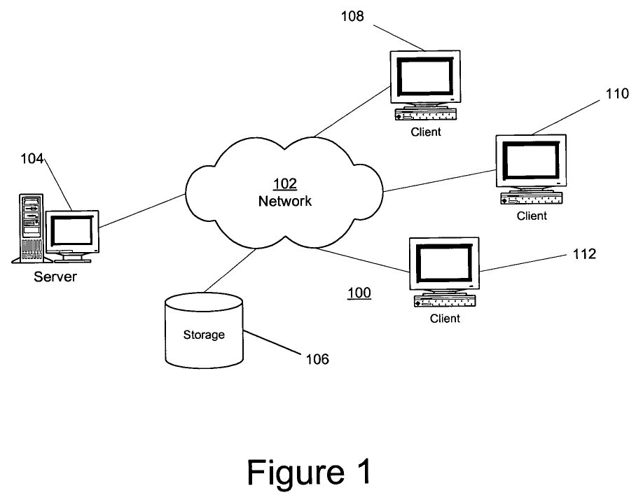

With reference now to the figures, and in particular with reference to FIG. 1, a pictorial representation of a distributed data processing system is depicted in which the present invention may be implemented.

Distributed data processing system 80 is a network of computers in which the present invention may be implemented. Distributed data processing system 80 contains network 82, which is the medium used to provide communications links between various devices and computers connected within distributed data processing system 80. Network 82 may include permanent connections, such as wire or fiber optic cables, or temporary connections made through telephone connections.

In the depicted example, server 84 is connected to network 82, along with storage unit 86. In addition, clients 88, 90 and 92 are also connected to network 82. These clients, 88, 90 and 92, may be, for example, personal computers or network computers. For purposes of this application, a network computer is any computer coupled to a network that receives a program or other application from another computer coupled to the network. In the depicted example, server 84 provides data, such as boot files, operating system images and applications, to clients 88-112. Clients 88, 90 and 92 are clients to server 84. Distributed data processing system 80 may include additional servers, clients, and other devices not shown. Distributed data processing system 80 also includes printers 94, 96 and 98. A client, such as client 90, may print directly to printer 94. Clients such as client 88 and client 92 do not have directly attached printers. These clients may print to printer 96, which is attached to server 84, or to printer 98, which is a network printer that does not require connection to a computer for printing documents. Client 90, alternatively, may print to printer 96 or printer 98, depending on the printer type and the document requirements.

In the depicted example, distributed data processing system 80 is the Internet, with network 82 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 80 also may be implemented as a number of different types of networks such as, for example, an intranet or a local area network.

FIG. 1 is intended as an example and not as an architectural limitation for the processes of the present invention.

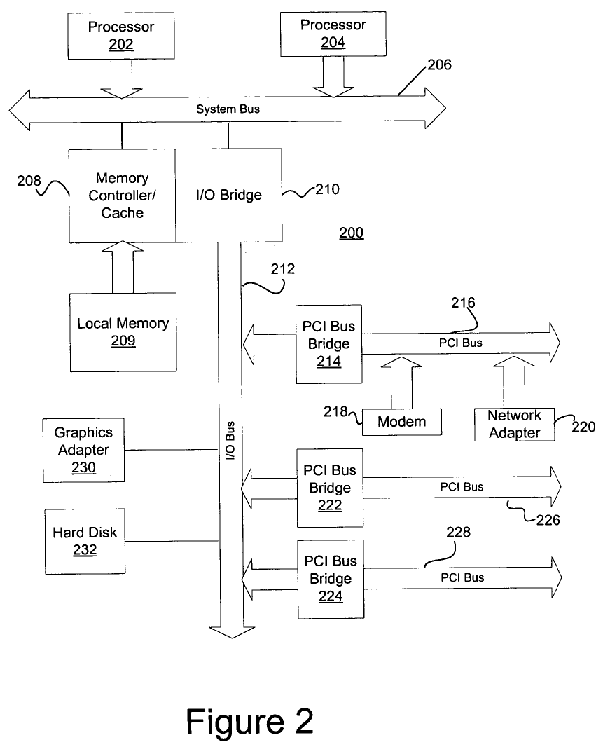

Referring to FIG. 2, a block diagram of a data processing system which may be implemented as a server, such as server 84 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 88-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

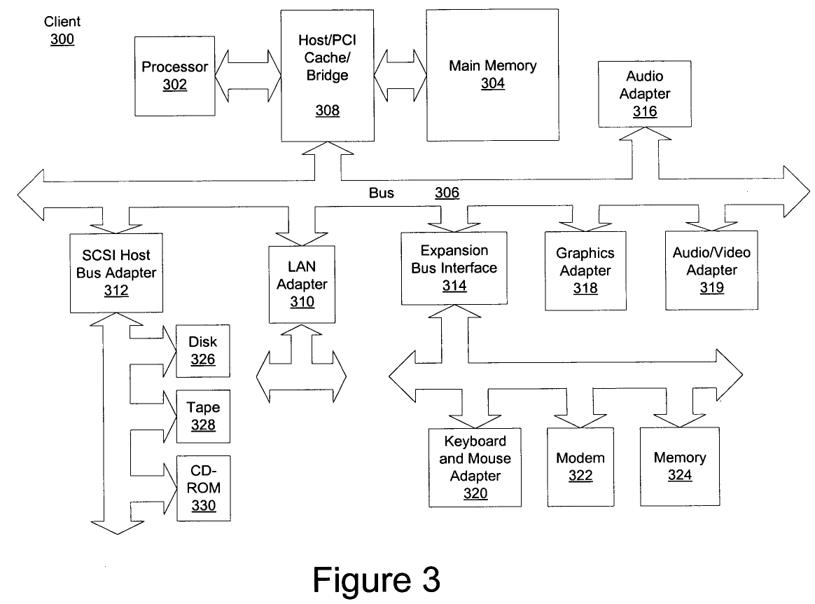

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

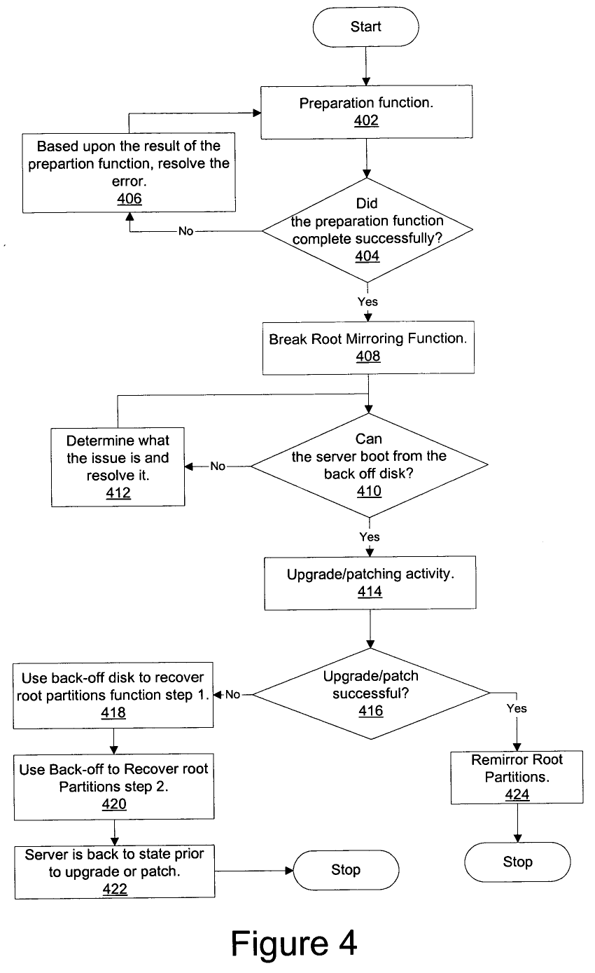

With reference now to FIG. 4, a diagram illustrating program function and process flow for upgrading a server, such as, for example, server 200 depicted in FIG. 2, and for restoring a root disk for the server if the upgrade fails is depicted in accordance with one embodiment of the present invention. To begin the upgrade and possible restoration process for a server, such as, for example, server 300 depicted in FIG. 3, a preparation function (step 402) is performed. In the preparation function (step 402), the current configuration of the server is determined. This is typically accomplished by presenting an administrator or user with a few questions and storing the replies to these questions for later use. The configuration data is stored in a directory and is referred to as a project. A project must be created before any of the other functions (steps 408, 418, 420, and 424) can be executed. The project must be complete and not manually modified to be valid for use by the other functions (steps 408, 418, 420, and 424).

Next, determine whether the preparation function (step 402) completed successfully (step 404). Typically, an administrator is prompted to answer this question with the process proceeding based upon the administrator's answer. If the preparation function (step 402) did not complete successfully, based upon the result of the preparation function, resolve the error (step 406) and continue with step 402. If the preparation function (step 402) did complete successfully, then perform the break root mirroring function (step 408).

The break root mirroring function (step 408) dissociates a mirror set of the managed file systems and provides that the back-off device is bootable outside of the Volume Manager without needing an external floppy diskette, compact disk (CD), or other external storage device. The partitions on the back-off device are fsck'ed (i.e., the file systems are checked and repaired) to ensure their integrity. As mentioned above, and to reemphasize, the preparation function (step 402) must be successfully executed and a project built for the break root mirroring function (step 408) to operate.

Next, it must be determined whether the server can boot from the back off disk (step 410). As before, an administrator is typically prompted for this answer. If the server cannot boot from the back off disk, then determine what the issue is that is preventing the server from booting from the back off disk and resolved the issue (step 412). If the server can boot from the back off disk, then proceed with the upgrade or patch to the server (step 414).

Next, determine whether the upgrade or patch was successful (step 416). As before, typically, an administrator will be prompted to answer this question. If the upgrade or patch was not successful, then proceed with the first step of using the back-off disk to recover the root partitions function (step 418). Thus, this first step of the recover root partitions function (step 418) occurs when the changes to the active disk (e.g., upgrade or patch) did not go as planned and must now be backed off of. Therefore, the system must be restored to the state it was in prior to the attempted upgrade or patch. Thus, the first of a two step process occurs that will switch the active plexes for the managed file systems (i.e., volumes). This first step of the recover root partitions function (step 418) sets the Volume Manager to use the plexes on the back-off device as the source plexes of the volumes, data in the managed file systems on the active device will be overlaid, and then the server is rebooted using the back-off device as the boot device.

Next, the second step of the back-off to recover root partitions function is performed (step 420). After the server has been rebooted using the back-off device as the boot device, instruct the Volume Manager to resynchronize the mirrors using the back-off device as the source of the mirrors. The reboot at the end of step 418 actually came up using the plexes on the back-off device as the live and enabled plexes for the volumes. Data in the managed file systems on the active device are now overlaid. Steps 402, 408, and 418 should be successfully executed for this step 420 to properly function. Once the data in the managed file systems on the active device are overlaid using the file systems on the back-off device, the server is back to the state it was in prior to the unsuccessful upgrade or patch (step 422).

On the other hand, if the upgrade or patch (step 414) was successful, then a remirror root partitions function (step 424) must be executed. Thus, since the changes to the active device went well, the back-off device needs to be resynchronized to the active device. Therefore, the remirror root partitions function instructs the Volume Manager to resynchronize the mirrors using the active device as the source for the mirrors. Data in the managed file systems on the back-off device will be overlaid. It should be noted that steps 402 and 408 should be successfully executed for this function (step 424) to be properly executed.

This process does all the work of preparing a restoration disk and restoring a root disk if an upgrade or patch is unsuccessful by executing a series of commands, checking the results of the commands and communicating back to the administrator the actions and the results. The administrator needs only to answer a few questions or select a function from a text based menu and is no longer required to know the proper command order and necessary syntax in order to restore a root disk.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for updating software on a data processing system having a root device and a back-off device which is a mirror of the root device, the method comprising:
executing a preparation function on the data processing system;
responsive to a determination that the preparation function completed successfully, breaking a root mirroring function of the data processing system such that changes to the root device do not affect the back-off device;
upgrading the root device of the data processing system; and
responsive to a determination that the upgrading the root device of the data processing system was unsuccessful, recovering an original state of the root device using the back-off device.

2. The method as recited in claim 1, further comprising:
responsive to a determination that the upgrading the root partition of the data processing system was successful, remirroring the root device such that the root device and the back-off device are substantially identical.

3. The method as recited in claim 1, further comprising:
prior to upgrading the root device, determining whether the data processing system can boot from the back-off device; and
responsive to a determination that the data processing system cannot boot from the back-off device, determining a reason for the inability of the data processing system to boot from the back-off device.

4. The method as recited in claim 1, wherein the preparation function comprises:
presenting a user with at least one configuration question; and
storing a response to the at least one configuration question as configuration data.

5. The method as recited in claim 1, wherein remirroring the root device such that the root device and the back-off device are substantially identical comprises:
setting a volume manager to use plexes on the back-off device as source plexes of volumes; and
rebooting the data processing system using the back-off device.

6. The method as recited in claim 5, further comprising:
overlaying data in the managed file systems on the root device using data from the back-off device

7. The method as recited in claim 1, wherein the data processing system is a server.

8. A computer program product in a computer readable media for use in a data processing system for updating software on a data processing system having a root device and a back-off device which is a mirror of the root device, the computer program product comprising:
first instructions for executing a preparation function on the data processing system;
second instructions for breaking a root mirroring function of the data processing system such that changes to the root device do not affect the back-off device if the preparation function completed successfully;
third instructions for upgrading the root device of the data processing system; and
fourth instructions for recovering an original state of the root device using the back-off device if the upgrading the root device of the data processing system was unsuccessful.

9. The computer program product as recited in claim 8, further comprising:
fifth instructions for remirroring the root device such that the root device and the back-off device are substantially identical if the upgrading the root partition of the data processing system was successful.

10. The computer program product as recited in claim 8, further comprising:
fifth instructions for determining, prior to upgrading the root device, whether the data processing system can boot from the back-off device; and
sixth instructions for determining a reason for the inability of the data processing system to boot from the back-off device if the data processing system cannot boot from the back-off device.

11. The computer program product as recited in claim 8, wherein the preparation function comprises:
fifth instructions for presenting a user with at least one configuration question; and
sixth instructions for storing a response to the at least one configuration question as configuration data.

12. The computer program product as recited in claim 8, wherein remirroring the root device such that the root device and the back-off device are substantially identical comprises:
fifth instructions for setting a volume manager to use plexes on the back-off device as source plexes of volumes; and
sixth instructions for rebooting the data processing system using the back-off device.

13. The computer program product as recited in claim 12, further comprising:
seventh instructions for overlaying data in the managed file systems on the root device using data from the back-off device

14. The computer program product as recited in claim 8, wherein the data processing system is a server.

15. A system for updating software on a data processing system having a root device and a back-off device which is a mirror of the root device, the system comprising:
first means for executing a preparation function on the data processing system;
second means for breaking a root mirroring function of the data processing system such that changes to the root device do not affect the back-off device if the preparation function completed successfully;
third means for upgrading the root device of the data processing system; and
fourth means for recovering an original state of the root device using the back-off device if the upgrading the root device of the data processing system was unsuccessful.

16. The system as recited in claim 15, further comprising:
fifth means for remirroring the root device such that the root device and the back-off device are substantially identical if the upgrading the root partition of the data processing system was successful.

17. The system as recited in claim 15, further comprising:
fifth means for determining, prior to upgrading the root device, whether the data processing system can boot from the back-off device; and
sixth means for determining a reason for the inability of the data processing system to boot from the back-off device if the data processing system cannot boot from the back-off device.

18. The system as recited in claim 15, wherein the preparation function comprises:
fifth means for presenting a user with at least one configuration question; and
sixth means for storing a response to the at least one configuration question as configuration data.

19. The system as recited in claim 15, wherein remirroring the root device such that the root device and the back-off device are substantially identical comprises:
fifth means for setting a volume manager to use plexes on the back-off device as source plexes of volumes; and
sixth means for rebooting the data processing system using the back-off device.

20. The system as recited in claim 19, further comprising:
seventh means for overlaying data in the managed file systems on the root device using data from the back-off device 21. The system as recited in claim 15, wherein the data processing system is a server.
